(19) United States
(12) Patent Application Publication
(10) Pub. No.: US 2014/0083005 A1
(43) Pub. Date: Mar. 27, 2014

(54) Multi-functional support bench

(71) Applicant: Steve Collins, Henderson, CO (US)

(72) Inventor: Steve Collins, Henderson, CO (US)

(21) Appl. No.: 13/626,664

(22) Filed: Sep. 25, 2012

(51) Int. Cl. F16M 11/32; B62B 3/02; A01G 9/02

(52) U.S. Cl. 47/66.6; 248/423; 280/35; 248/558

(57) ABSTRACT

An improved portable support bench frame is disclosed. The support bench frame disclosed herein provides for portability while simultaneously sustaining large weight loads on the bench. The support bench frame is also vertically adjustable to provide advantages during certain uses and to also lower the bench's center of gravity when needed. The lightweight nature of the frame makes it easier to transport and disassemble, while the modular nature of the apparatus allows components to be easily added or removed. The portable bench frame disclosed herein may be used in any field where a supporting frame might be necessary such as building, design, architecture, models, horticulture, or presentations.

### STATEMENT REGARDING FEDERALLY SPONSORED RESEARCH AND DEVELOPMENT

Not Applicable.

### FIELD OF THE INVENTION

This invention relates to support bench frames and improvements to more easily provide an efficient workspace, support a large weight load, quickly adjust a bench's center of gravity, and maintain portability.

### DISCUSSION OF RELATED ART

Support bench frames have been used by craftsmen as a means to hang tools and articles such as paint cans, to mount large platforms such as a model train landscapes or art canvases, or to support or hang heavy items such as plant trays for suspension above a ground surface. However, it is also currently burdensome to adjust or move large heavy articles placed on a support bench such as full plant trays, works of art currently in progress, exhibits, architectural models, or model train landscapes because most benches do not have wheels or a means to easily transport the item or adjust the angle at which it is placed.

Support benches exist that sustain large weight loads, but benches in the prior art are neither vertically adjustable nor are they very portable. To transport a fully loaded support bench, one must first disassemble or remove the platform(s) or items from the frame component. Disassembly of a support bench and removal of the items therefrom is a burdensome activity that requires significant time and resources. As a result, there is a need for an improved support bench that can sustain heavy weight loads, has an adjustable center of gravity, and remain portable. Even during shipping and transport, support benches can pose a problem as far as logistics compared to other items given their large size.

U.S. Pat. No. 866,088 by Templin describes an improved means to fully propagate and grow early vegetable and flower plants. The invention is also adapted for use as an indoor plant stand whereby plants may be placed and maintained in a healthy growing condition. This apparatus includes a plurality of legs, a lower platform section and an upper platform section, both oriented perpendicular to the placement of the legs. The upper tray platform component also includes both a pan and a tray having a perforated bottom for water to drain that fits in the pan. The invention by Templin includes both upper and lower platform frames but only provides a single continuous surface. The bench legs are also located at the edges of the upper platform section, which is substantially different from the location of the legs disclosed in your invention. Finally, unlike the present invention neither platform level of the apparatus to Templin can be vertically adjusted.

U.S. Pat. No. 4,603,506 to Powell Jr. describes one or more plant growing trays that are supported via a tubular support frame constructed of PVC pipe providing a support system for plant-growing trays and a storage chamber for fluid growing solution. The apparatus to Powell Jr. also includes a timing mechanism so that air pressure can regulate when growing solution is distributed throughout the trays. This invention includes a plurality of modular tubing and joints to create a single support platform for one or more plant trays, but does not provide improved adjustability or portability to the user.

U.S. Pat. No. 4,756,119 to Chabot discloses a base support apparatus for seed trays. The invention to Chabot discloses a tray including a flat frame with a plurality of compartments, each having an opened bottom that would support a plant tray, and retractable supporting components that move between a stored position and an standing position where they are placed in a configuration describing an angle of more than 90 degrees to the stored position, thereby leaving a space below the frame to allow air to circulate or a water reservoir component to be placed underneath. The invention to Chabot is an improved apparatus to support only seed trays. Moreover, it is not vertically adjustable, nor is it designed to sustain a large amount of weight.

U.S. Pat. No. 5,448,853 to Harman discloses a portable plant-growing cart that can accommodate a plurality of trays. The invention is a growing cart constructed of a plurality of interconnected rigid frames secured via hinges that support one or more plant trays thereon with legs and wheels. A moveable light source is also supported from the frames above one tray to provide a light source, which can be reflected back toward the plants via a reflective shroud. Although this wheel cart is portable, it does not provide several levels of storage nor is it vertically adjustable.

U.S. Pat. No. 5,673,511 to Holtkamp Jr. discloses an apparatus for indoor horticulture that includes a multi-platform self-watering tray system for supporting a plurality of plants, which can also be watered from a continuous water reservoir in the bottom of the system via capillary action so that water can circulate upwards throughout the system. This system applies mostly to potted plants and the plant support platforms are not intended to be adjustable upward or downward. The trays allow for improved circulation of water and do so through angling the pots so that water will drain accordingly. However, the invention to Holtkamp does not provide a portable solution without having to disassemble and remove the components, reducing its utility.

U.S. Pat. No. 5,983,564 to Stragnola claims a plant growing station having a growing tray on a watering bench, the tray adapted to expose a pumping compartment within the lowermost portion of the watering bench, the tray also adapted to filter and collect water that has been sprayed thereon. The invention by Stragnola features a watering bench sized to fit a planting tray and a water-pumping component in the bench's lowermost portion, which is also connected to a spraying mechanism via a tube from the lower portion to the top portion of the apparatus. A water pump moves water from the lower portion of the water collection area through the tube to the spraying mechanism wherein water is provided to the plants within the apparatus. Although this invention provides a self-sustaining means to grow plants indoors, the invention does not provide portability or adjustability.

U.S. Pat. No. 5,987,812 to Knell discloses a plant stand system for growing plants on plant trays from seedlings via multiple T-shaped platforms and L-shaped light arms wherein the lights can be adjusted in height via one or more flexible chain members. The invention to Knell is an all-in-one adjustable indoor plant stand system, but it is distinct from your invention for several reasons. First, Knell's invention has a higher center of gravity and is more likely to fall over than the invention disclosed herein. Because the weight on the invention disclosed herein is more evenly distributed along a single axis, it is better balanced and less likely to fall over during use in comparison to the multi-platform system claimed by Knell. Next, Knell's invention fails to be as expandable or as customizable as the present invention. The platform components on Knell's invention can be adjusted upward or downward along the y-axis but cannot be adjusted outward or inward to support specific plant trays.

U.S. Pat. No. 6,385,899 to Treganza discloses a decorative plant stand with integrated drainage and rotation features. Treganza's invention enhances the growth of indoor plants by providing portability and improved drainage. Specifically, the invention provides a platform and support component with internal drainage water collection and storage subsystem with wheels so that the apparatus could be utilized or rotated by the user. The invention by Treganza also includes a drainage system with shut-off valve, a water storage system, and a single support component where the drainage and water storage system pass within. Although this invention improves portability and facilitates drainage, it fails to help more than the simple hobbyist. Commercial or larger scale indoor horticulturalists require a system that is simple, useful for a large number and variety of plants, modular, and easily portable. A simplified device such as the present invention can accomplish the same utility achieved by this invention.

U.S. Pat. No. 7,303,228 by Thomas discloses a foldable bench designed for use in any number of fields. The bench disclosed by Thomas is adjustable and can be used to support large weight loads on the flat surface of the bench. However, the bench to Thomas fails to be vertically adjustable by the user. The bench to Thomas also does not improve portability nor does the positioning of the legs allow the bench to accommodate larger weight loads.

U.S. Pat. No. 7,654,036 to Shouse and Reck discloses a rack or stand for growing plants that is designed and configured to be convertible into various sizes that also support various light sources. Unlike other racks in the art, the rack disclosed by Shouse and Reck allows a user to configure and modify the rack so that it can support plant trays of various sizes. Although Shouse and Reck attempt to overcome the customization and expandability issue by increasing the use of 2′×4′s, it does not include a variety of elements disclosed by the present invention. First, there is no use of metal casters along the distal ends of the legs to help make the rack more transportable. Moreover, there is no lower or secondary storage platform to provide an additional support level.

U.S. patent application US200910077876 by Eghbal and Golfo discloses an expandable plant growing frame tray and pots. Eghbal and Golfo disclose unique tubular joiners that work with standard tubing to expand a frame and accommodate plants of different sizes and at different stages of development. The frame disclosed by Eghbal and Golfo allows a user to expand the area of the platform support component, but does not allow the user to adjust the platform vertically. Unlike the invention disclosed herein, Eghbal's invention also fails to be portable when supporting large weight loads.

U.S. Patent application US2010/0107489 by Silver discloses an adjustable plant growing stand, a mounting clip for attaching a lighting fixture to an adjustable plant growing stand, and a method for lighting plants. The stand includes a frame with a plurality of substantially parallel legs, an upper fixed shelf affixed to the legs, and a lower adjustable shelf coupled to the legs via a sliding means. The lower shelf can include attachments configured to fix the vertical height of the lower section relative to the upper section. Although both the present invention disclosed and the invention applied for by Silver provide open frame-like upper and lower sections without a flat platform surface that are vertically adjustable as well as a plurality of legs, Silver's invention fails to be portable when supporting large weight loads.

Therefore, there is a need for an improved support bench frame that is modular, maintains portability while sustaining a large weight load, and has the capability to adjust the table legs vertically in order to place the frame at an angle between 0 and 25 degrees to the surface plane. There is also a need for a support bench that can support a large weight load but can also be easily and inexpensively shipped from a manufacturer to a user. The present invention accomplishes these objectives and more.

### SUMMARY OF THE INVENTION

The present device is a support bench that is lightweight, and can sustain large weight loads while remaining portable.

As will be discussed in more detail, the focus of the present invention is to provide a support bench that is an improvement over support benches in the prior art. The disclosed apparatus can support any number of surfaces so long as they are within the size and weight limits of the support bench.

One goal of the present invention is to provide a lightweight support bench that can support several plant trays, platforms, canvases, meshes, or a series of items or articles while still remaining easily portable.

Another goal of the present invention is to provide a support bench wherein a surface can be vertically adjusted at either or both ends of the frame. The modular support bench assembly also allows a user to interchange any number of surfaces or trays along the supporting portion of the frame.

It is another goal of the present invention to provide a support bench that can be quickly disassembled or stored by a user.

It is another goal of the present invention to provide a support bench that includes a hollow, rigid, tubular frame and hollow, rigid, tubular leg components.

Another goal of the present invention is to provide a multi-functional work surface where space may be limited and constant scrutiny or surveillance over the workspace and goods may be required.

Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an isometric view of the portable support bench.

FIG. 2 is an isometric view of the three-way vertex joint component used in FIG. 1.

FIG. 3 is an isometric view of the two-way vertex joint component used in FIG. 1.

FIG. 4 is a top-down view of the portable support bench of FIG. 1.

FIG. 5 is a side view of the portable support bench of FIG. 1.

FIG. 6 is an isometric view of an alternate embodiment of the present invention that includes a light stand.

FIG. 7 is an isometric view of the portable support bench of FIG. 1 with a plurality of plant trays.

FIG. 8 is an isometric view of the portable support bench of FIG. 1 with attached bag and mesh accessories.

### DETAILED DESCRIPTION OF THE PREFERRED EMBODIMENT

Illustrative embodiments of the invention are described below in the accompanying Figures. The following detailed description provides detailed schematics for a thorough understanding of and an enabling description for these embodiments. One having ordinary skill in the art will understand that the invention may be practiced without certain details. In other instances, well-known structures and functions have not been shown or described in detail to avoid unnecessarily obscuring the description of the embodiments.

Also, it is noted that as used herein and in the appended claims, the singular forms, “a,” “and,” “said,” and “the” include plural references unless the context clearly states to the contrary. Conversely, it is also contemplated that the claims disclosed herein may be drafted as to require singular elements or exclude any optional element indicated to be so here in the accompanying text or drawings. This statement is to serve as an antecedent basis for the use of exclusive terminology as “solely,” “only” and similar terms in connection with the recitation of claims elements or the use of a “negative” claim limitation(s).

Further, it must be clarified that, for clarification purposes, the embodiments of the present invention will be described with reference to the terms “bench,” “frame,” “support component,” “vertex joint,” and “surface” are used to provide a basic understanding of the operation of the systems, methods, and apparatuses of this invention. Thus, the terms “bench,” “frame,” “support component,” “vertex joint,” and “surface” should not be construed as limiting in any way the systems, methods, and apparatuses of this invention.

Shown throughout the Figures, the instant invention is generally directed toward benches used to store plant trays, and general plant storage, but it can also be used for any number of tasks.

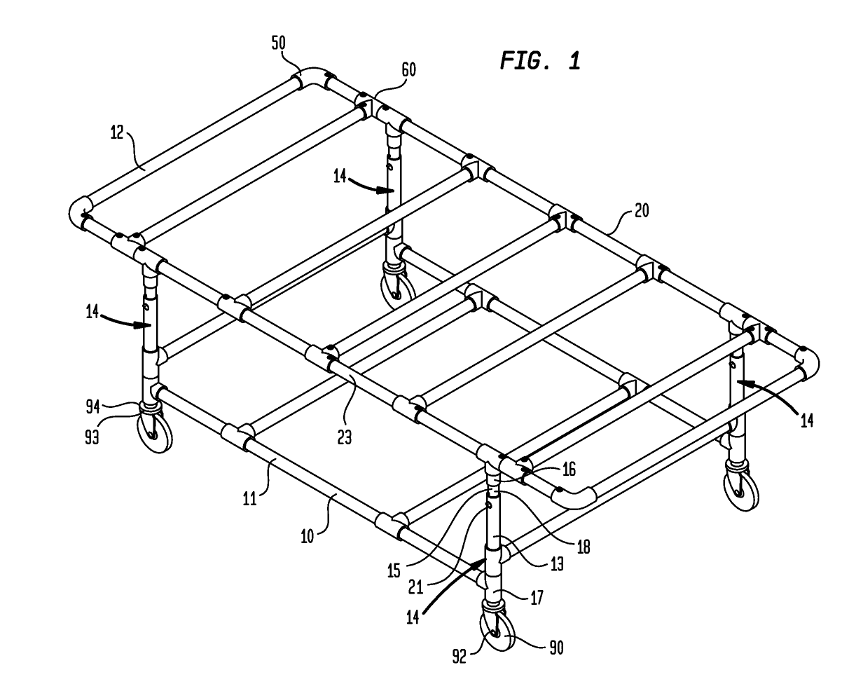

FIG. 1 is an isometric view of the portable support bench. The support bench comprises a frame component 10 and an upper surface support component 20 that is placed above and perpendicular to the frame component 10. The frame component connects to the upper surface support component via a plurality of three-way vertex joints 60 that can be inserted into the proximal end of each leg 14 components.

The frame component 10 includes a plurality of legs 14 arranged vertically to the plane of the ground with proximal ends 16 and distal ends 17, one or more three-way vertex joints 60, one or more lower level elongated pipes 11, one or more secondary support pipes 12, and one or more end components 19 placed at the distal end 17 of each leg 14 of the frame component 10. The various leg end components 19 discussed herein are again mentioned in the claims as the ground support means.

The legs 14 of the frame component 10 comprise an outer pipe 13 and a telescoping inner metal tube 15 designed to allow the height of a leg 14 to be adjustable as desired with end components 19 at the distal end 17 of a leg 14. The legs 14 are oriented parallel to a longitudinal axis and are perpendicular to the ground. Each outer pipe 13 and telescoping inner metal tube 15 also includes a plurality of spaced ports 18 designed to receive a securing pin 21 to lock the telescoping inner metal tube 15 and the outer pipe 13 component to a specific height desired by the user. Fitted vertically around the legs 14 are a plurality of three-way vertex joints 60 arranged equally spaced from one another to interconnect the ends of one or more lower level elongated pipes 11 and secondary support pipes 12 together to create a lower level rectangular perimeter and supporting surface around the legs 14.

The leg end component fits concentrically around the distal end of the telescoping inner metal tube 15 of the leg 14 component. Leg end components contemplated by the inventor include stem swivel caster wheels 90 with one or more washers 94 to the swivel joint 93 to reduce possible flutter and/or rubber leg end pieces to prevent horizontal movement of the bench. The casters wheels 90 are contemplated to be able to pivot along a three hundred sixty (360°) degree axis from the floor and include locking mechanisms 92 to secure a wheel 90 when the bench reaches a desired space. Use of the removable swivel casters 90 substantially increases the portability of the bench when supporting large weight loads. Use of rubber leg end pieces as an alternative leg end component 19 is beneficial when the bench will be at a single location for an extended period of time and will not need to be moved. It is possible that any combination of caster wheels 90 and/or rubber leg end pieces at the distal 17 ends of the leg 14 components may be used to practice the invention.

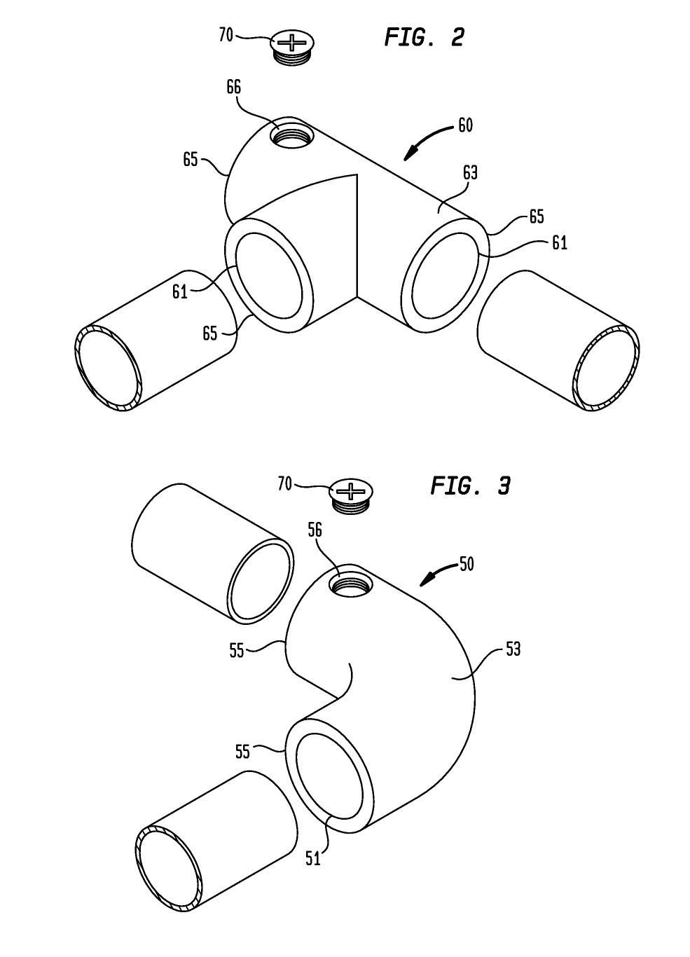

FIG. 2 shows the details of the three-way vertex joint 60 used in the present invention. The three-way vertex joint 60 is designed to fit around or into an upper- or lower-level elongated pipe component, the leg outer pipe, or the secondary support pipes. The three-way vertex joints 16 comprise a total of three annular openings 61 arranged in a hollow cylindrical T-shaped joint. The edges 65 of the two annular openings 61 are connected along a cylindrical surface 63 that can be fitted around one of the aforementioned pipe components. The third annular opening 61 is at the center of the cylindrical surface 63 along a longitudinal axis and protrudes from the cylindrical surface 63 as an opening that can fit into the end of a pipe component. The three-way vertex joint 60 also includes a fastening means 70 comprising one or more locking ports 66 placed along the outer surface 63 of the three-way vertex joint 60 designed to receive one or more fasteners to secure the three-way vertex joint 60 to the end of a leg 14 or pipe component without it being able to freely rotate.

Once placed around a pipe component, a three-way vertex joint 60 can be rotated around a pipe component and be secured via the locking ports 66 located along the cylindrical surface 63 of the joint. Ideally, a three-way vertex joint 60 will be placed concentrically around a pipe component so that the third joint opening can receive the proximal 51 end of a leg 14, the end of an upper- or lower-elongated pipe or the end of a secondary support pipe arranged perpendicular to an upper- or lower-elongated pipe to create a supporting surface that can undergird one or more objects. Any number of materials may be used to manufacture the three-way vertex joint 60 component including poly-vinyl chloride, acrylo-nitrile-butadiene-styrene (ABS), high-density polyethylene (HDPE), other plastics, composites, wood, metal, alloys, and combinations thereof. Possible fasteners for securing a three-way vertex joint 60 to a leg, upper, or lower elongated pipe include screws or bolts, and combinations thereof.

FIG. 3 shows the details of the two-way vertex joint 50 used in the present invention. The two-way vertex joints 50 fit into the ends of the upper-level elongated pipe component or the ends of one or more secondary support pipes. The two-way vertex joint 50 comprises two annular openings 51 formed in a hollow L-shaped or elbow-shaped joint and are used to provide edges 55 to the upper surface support component 20. The edges 55 of the two annular openings 51 are connected along a surface 53 to form a ninety degree (90) curved cylinder designed to receive an upper-level elongated pipe 23 into one annular opening and a secondary support pipe 12 into the other annular opening. The two-way vertex joint 50 also includes a fastening means 70 comprising a fastener and one or more locking ports 56 placed along the outer surface 53 of the joint designed to receive one or more fasteners that secures the two-way vertex joint 50 to the end of an upper-level elongated pipe 23 or secondary support pipe 12.

The two-way vertex joint 50 is necessary to combine the secondary support pipes 12 to the upper-level elongated pipes 23 and create the outer perimeter of the upper surface support component 20. Any number of materials can be used to manufacture the two-way vertex joint component 50 including poly-vinyl chloride, acrylo-nitrile-butadiene-styrene (ABS), high-density polyethylene (HDPE), other plastics, composites, wood, metal, alloys, and combinations thereof.

The completed upper surface support component 20 is placed perpendicular to the proximal ends 16 of the legs 14 at the top of the frame 10 and connects to each leg 14 via one or more three-way vertex joints 60 placed along the upper-level elongated pipes 23.

Based on the intended needs, any number of secondary support pipes 12 may be added or removed by placing or removing one or more three-way vertex joints 60 placed around the upper-level elongated pipes 23 to adjust space for plant trays of varying sizes, depths, or other articles to be placed on the upper surface support component 20. Because plant trays and other surfaces come in varying sizes that may not necessarily fit the bench's dimensions for normal use, it is important that the bench maintain the maximum flexibility to be useful to horticulturists or hobbyists of all types.

It is contemplated that a user may substitute four-way vertex joints 80 in place of three-way vertex joints 60 at the leg 14 intersection to allow a user to quickly interchange and add-on accessories to provide additional functionality to the bench. This embodiment is explored further below in FIG. 8. The upper surface support component 20 as shown in FIG. 1 is constructed so that the upper level elongated pipes 23 are arranged parallel to one another and connected via the two-way elbow joints 50 creating a rectangular perimeter. Further, secondary support pipes 12 are placed perpendicular to the upper level elongated pipes 23 and the secondary support pipe 12 ends are fitted into the three-way vertex joint 60 openings placed around the elongated pipes 23.

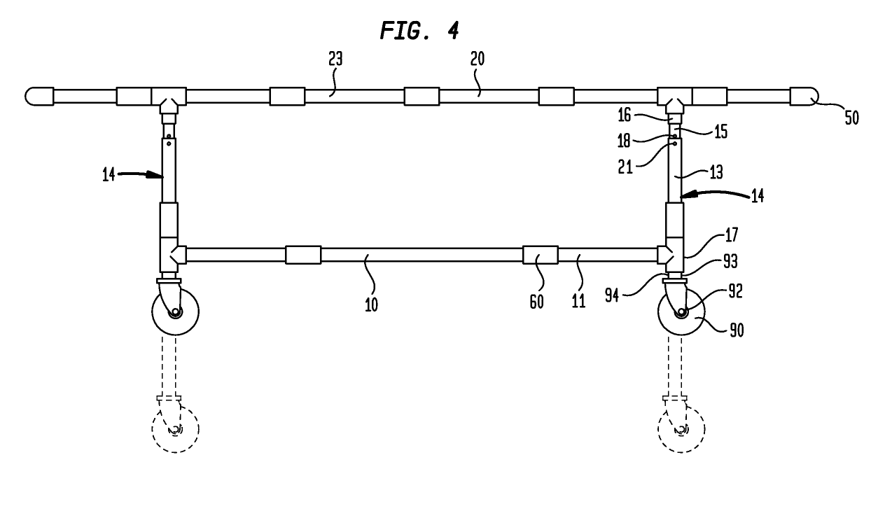

FIG. 4 is a side view of the portable support bench. Near the distal 17 end of the leg 14 components are a plurality of spaced ports 18 on both the telescoping inner metal tube 15 and the outer pipe 13 designed to receive a securing pin 21 placed between the telescoping inner metal tube 15 and the outer pipe 13 of the leg 14. Placement of the securing pin 21 through the ports 18 of both the telescoping inner metal tube 15 and the outer pipe 13 can secure the height of the leg 14 to the user's desire.

One embodiment contemplated by the inventor for horticultural purposes includes using the arrangement of the elongated 23 and secondary support pipes 12 along the upper surface support component 20 to undergird one or more plant trays. The bench as disclosed herein can support the weight of one or more plant or flood trays complete with water and or soil. The upper sections of plant trays can be rested on and fit along the upper surface support component 20 via the elongated pipes 23 and secondary support pipes 12, creating a peripheral support ledge The two-way 50 vertex joints fit into the ends of the elongated pipes 23 and the three-way vertex 60 joints fit concentrically around the elongated pipes and into the ends of a secondary support pipe. A plurality of three-way vertex joints 60 are also fitted concentrically around the lower level elongated pipe 11 creating the lower-level support frame 10. Once the proximal 16 ends of the lower-level support frame 10 legs 14 are attached to a three-way vertex joint 60 fitted along the upper level elongated pipe 23, the upper and lower components are connected. The resulting structure can then support multiple platforms, trays, textiles, and accessories, in any number of combinations using the various support pipes and/or vertex joints as a modular system. Each table leg is supported by stem swivel caster wheels 90, a swivel joint 93, one or more washers 94, and a locking mechanism 92 to reduce possible flutter and/or rubber leg end pieces to prevent horizontal movement of the bench.

For horticultural usage, it is contemplated that the frame component 10 be used to load a water or nutrient tray to hydrate plants kept in one or more trays located above along the upper surface support component 20. Water or nutrients can then be delivered and cycled to plant trays on the upper surface support component 20 via one or more pump systems placed along the frame component 10.

The support platform was conceived based on the need to store and/or move heavy items using a light weight and easy to assemble system, ranging from storing multiple gallons or liters of various liquids other substantial items such as full plant trays or large platforms in excess of 8′×4′. In the preferred embodiment, the support bench disclosed herein can support weights of up to four-hundred (400) pounds or one hundred-eighty (180) kilograms if distributed along the platform. The ideal embodiment of the bench system weighs under thirty (30) pounds or thirteen (13) kilograms, making it a desirable choice for projects that require assembling and moving of a large or heavy item(s).

Based on the user's needs the legs 14 of the support bench may be adjusted vertically upwards or downwards. FIG. 4 also shows in phantom the functionality of the adjustable leg 14 components. The present invention provides improves functionality because the bench legs 14 can telescope upwards or downwards. The plurality of leg ports 18 near the distal 17 end of the bench leg 14 gives a user a number of options regarding the variety of heights that the bench may be configured at because one or more securing pins 21 that fit in the bench leg ports 18 allow a user to lock in a desired leg height. Moreover, the height of each leg 14 can be individually adjusted allowing one or more corners of the bench to be adjusted upward or downward based on the user's needs. The completed upper surface support component 20 can be connected to the frame 10 when adjusting the bench legs 14 upwards or downwards. Allowing the bench legs 14 to be vertically adjustable can inexpensively help with issues such as water flow, desired elevation, wiring, cleaning, or more.

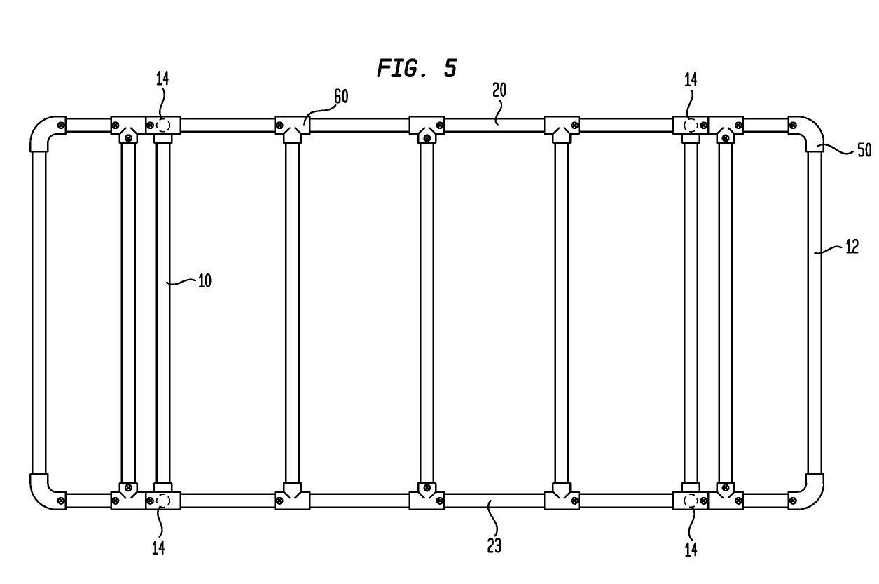

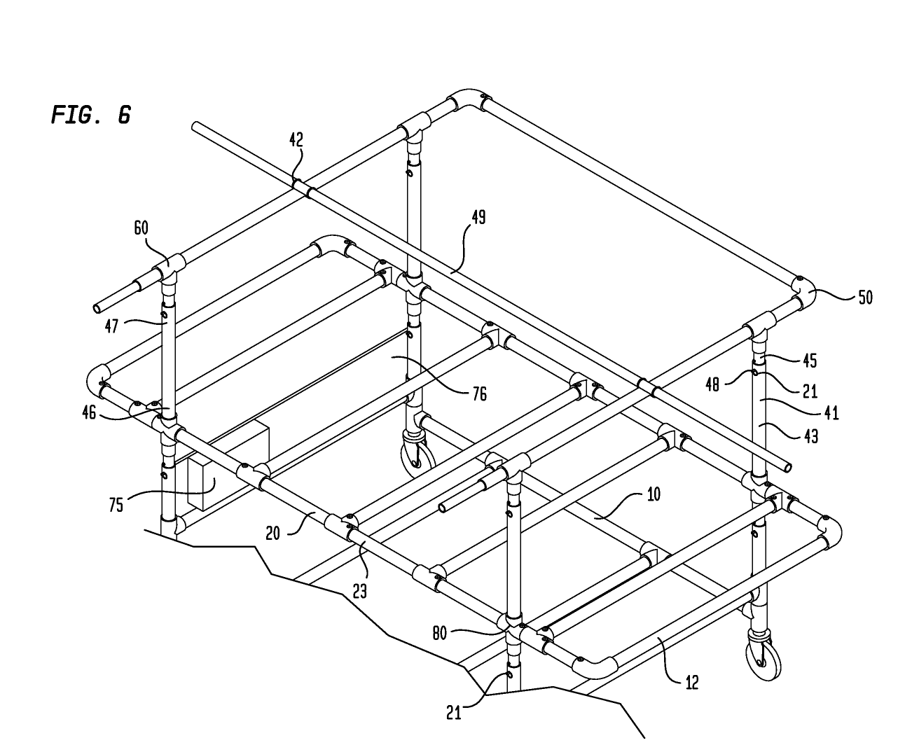

FIG. 5 shows a top-down view of the assembled bench invention. Shown in the foreground of FIG. 5 is the upper surface support component 20. The frame component 10 is located in the Figure in the background behind the upper surface support component 20. The upper surface support component 20 attaches to the frame component 10 via a plurality of three-way vertex joints 60 fitted along the elongated pipes 23 that form the upper surface support component 20 that connect to the bench legs 14. As shown in FIG. 5, the upper surface support component 20 is placed perpendicular and flat to standing legs 14 of the bench. Once connected to the legs 14, the orientation of the secondary support pipes 12 perpendicular to the upper level elongated pipes 23 connected via the two-way vertex joints 50 and three-way vertex joints 60 create a multi-functional platform that provides a number of options to the user during use.

One embodiment contemplated by the inventor includes using the assembled bench to support a heavy flat or contoured platform such as that used by a toy train enthusiast, set designer, arts and craftsperson, or an architect for a building project. Enthusiasts or set builders can easily create, quickly modify, and move scale representations of scenery and environments on the bench. The heavy weight loads that can be sustained by the platform allows for any number of items or model environments to be placed, stored, modified, and/or moved when supported by the bench. The portable nature of the bench allows the set or the project to be easily moved while still on the bench.

Another embodiment contemplated by the inventor includes using several four-way vertex joints that allow a user to add accessories to the bench such as a light stand, magnifying lens, or hydration system via the vertex joints in place of three-way vertex joints 60. The upper surface support component 20 ideally features a plurality of two-way vertex joints 50, three-way vertex joints 60, a plurality of upper level elongated pipes 23, and a plurality of secondary support pipes 12. The ratio for the length of the upper level elongated pipes 23 compared to that of the secondary support pipes 12 that a:b is preferably 2:1.

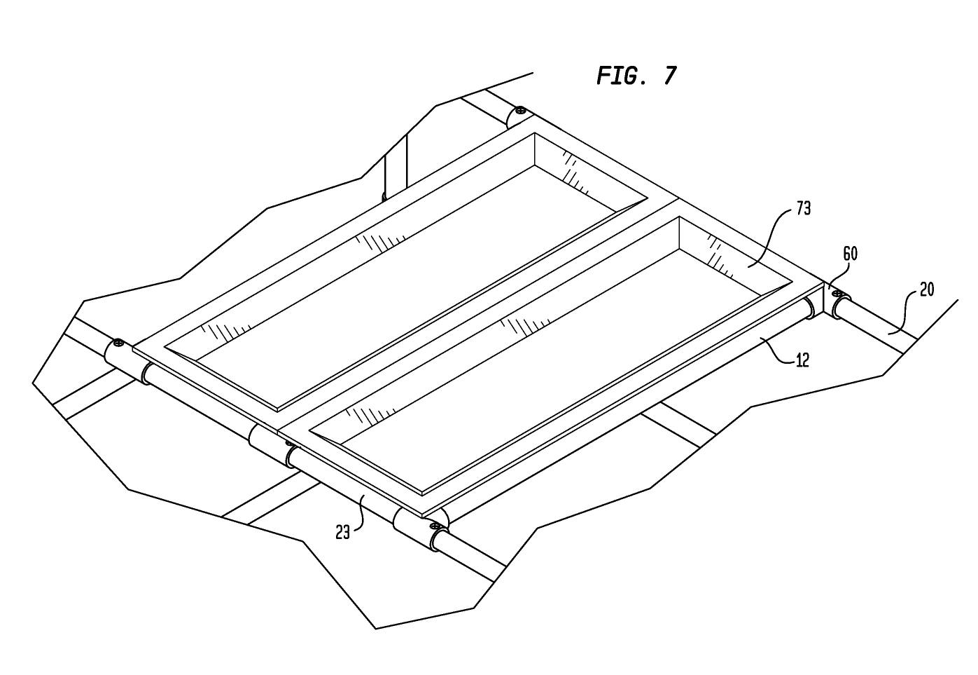

FIG. 6 shows an embodiment of the present invention that includes an additional light stand accessory. The bench is substantially similar to the bench in FIG. 1, however it also includes several additions that allow a user to attach one or more lights to the bench via a light bar 49 placed over the upper surface support component 20. The light holder stand components 43 comprise proximal 46 and distal 47 ends, ports 48 to receive a securing pin 21, a telescoping inner metal tube 45 and an outer cylinder 41 that fits concentrically around the telescoping inner metal tube 45. The proximal 46 end of each light holder stand 43 is connected to each open four-way vertex joint 80. First, in substitution of the three-way vertex joints 60 used to fasten the upper-level support component 20 to the frame, one or more four-way vertex joints 80 are used instead. One or more light holder stands 43 are attached at the proximal 46 ends to one or more four-way vertex joint 80 openings placed on the upper surface support component 20. The distal ends 47 of the light holder stand 43 connect to one or more three-way vertex joints 60 which also connect to a secondary support pipe 12 through the vertex joint annular openings 61. Once a secondary support pipe 12 is secured through the annular openings of the raised three-way vertex joints 60, the light bar 49 may be rested against and secured via a light bar securing means 42 to the light stand.

To secure lighting components at a desired height, the securing pin 21 may be placed between the telescoping inner metal tube 45 and outer cylinder 49 of the light holder stand 43 via a port 48. The proximal 46 end of each light holder stand 43 connects to the bench via a four-way vertex joint 80 fitted along the upper-level elongated pipes 23. Once the proximal 47 end of each light holder stand 43 is fitted into a corresponding three-way vertex joint 60, a two-way vertex joint 50 is placed at the distal end 47 of each light holder stand 43. A secondary support pipe 12 is connected perpendicular to the light holder stands 43 via one or more two-way vertex joints 50 at the distal 46 ends of the light holder stand 43.

The light stand and accompanying accessories may be used for any number of purposes. A set designer building a scale model may require placement of a light at a specific height or angle. A horticulturalist may require light at a certain height or angle for only a few weeks or hours at a time. The present embodiment accomplishes these goals because the component supporting a lighting device may be moved along both a horizontal and vertical axis. The result is a light stand that provides maximum flexibility for the user based on the adjustability of the components.

FIG. 6 also includes a power source 75 accessory as part of the present invention connected to two bench legs via a power source platform 76. The power source 75 is intended to provide a single electrical connection point for components attached to the bench while also connecting the various components to an electrical power outlet. A power source 75 would also be beneficial if using the bench as a work-space or as a surface to support a model train set. Having a number of extra wires connecting separately to various electrical outlets reduces the portability of the bench.

The power source 75 is preferably placed between and parallel to two bench legs and as part of the frame component 10 that is attached to the power source platform 76. The preferred location for the power source 75 and platform 76 on the bench is ideal because the available surface area on the bench for use is maintained and the power source 75 is minimally exposed to any liquids that might cause damage. The power source 75 is contemplated to attach to the frame component 10 via one or more ports on the power source 75 that align with leg ports 18 placed that fasten via a securing means. The inventor also contemplates protecting the power source 75 from liquids that could cause damage such as water by encasing the power source in rubber or other materials that would prevent liquids from damaging the power source if exposed.

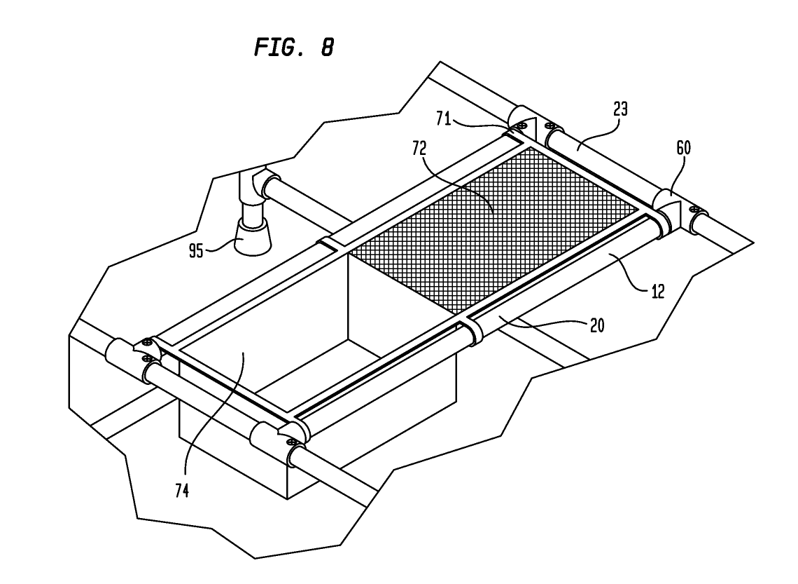

FIG. 7 shows an isometric view of the support bench described in FIG. 1 with one or more plant trays 73 placed along the upper surface support component 20, three-way vertex joint 60, and the secondary support pipes 12. In FIG. 7, the embodiment is the disclosed bench with additional plant trays 73 rested perpendicular to the upper-level elongated pipes 23 and parallel to the secondary support pipes 12. Placement of one or more plant trays 73 along the upper surface support component 20 creates an ideal platform to host one or more plants. Based on the number and arrangement of the secondary support pipes 12, any width of plant tray 73 between 8′×4′ may be used. With additional components, any plant tray 73 of any length or width within the range of 8′×4′ may be rested along the pipes of the upper surface support component 20.

FIG. 8 is a partial view of the support bench holding a variety of articles via the upper surface support component 20. The perpendicular arrangement of the fixed secondary support pipes 12 to the upper-level elongated pipes 23 via the three-way vertex joints 60 allows placement of items or articles along the upper support surface support component 20. Articles such as tools, painting equipment, or storage items can be placed on the upper support frame component 20 while the bench is in use. Horticultural related items such as plant trays water trays may also be rested on the upper surface support component 20 as shown in FIG. 7. Finally, one or more hangars 71 and accessories such as a bag 74 or mesh 72 may be wrapped around one or more upper-level elongated 23 or secondary support pipes 12 using a clamp, hook and loop fastener, ring.

When adding hangars 71 and accessories to the upper surface support component 20, users can add functionality to the upper surface support component 20, act as a net receptacle 74 to receive one or more objects, act as a mesh screen 72, or other semi-permeable barrier to filter unwanted impurities, and combinations thereof via the hangar 71 accessories. Hanging items from the support bench allows a user to easily and quickly access or spray paint an article while the portable nature of the bench allows a user to perform the task with minimal exposure to an already clean environment. One or more rubber stoppers 95 are added to the distal end of the leg components to prevent unnecessary movement of the bench.

One embodiment of the invention contemplated by the inventor in FIG. 8 includes stretching or placement of one or more mesh screens 72, nets 74, or other surface(s) across one or more secondary pipes 12 of the upper or lower levels of the bench via one or more hangars 71 attached to the accessory. A flat surface may be used in one or more locations to store and place items on the bench. The mesh screen 72 as shown in FIG. 6 may be used to filter plant or other solid impurities. A net receptacle 74 may be used to store processed product or refuse while using the bench. The additional depth created by a net receptacle 74 increases the cubic space for storage available to a user. Moreover, a variety of articles such as mesh screens 72 or nets 74 may be used and interchanged by the user to maximize the desired functionality of the bench.

While a particular embodiment of the invention has been described and disclosed in the present application, it is clear that any number of permutations, modifications, or embodiments may be made without departing from the spirit and the scope of this invention. Accordingly, it is not the inventor's intention to limit this invention in this application, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

In light of the above “Detailed Description,” Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A multi-functional support frame, comprising:
a frame component; and an upper surface support component;
the frame component comprising a plurality of securing pins, a plurality of three-way vertex joints, a plurality of lower-level elongated pipes with one or more equally spaced ports along the surface of the pipe designed to receive a securing pin and ends, a plurality of secondary support pipes comprising a shaft and ends, and a plurality of legs comprising telescoping cylindrical pipes with proximal and distal ends placed perpendicular to the floor and a plurality of equally spaced ports along the surface of the legs designed to receive one or more securing pins, one or more leg end components placed at the distal end of the legs, wherein one or more three-way vertex joints are placed concentrically around the legs to receive the ends of one or more lower-level elongated pipes or secondary pipes placed perpendicular to the longitudinal axis, a plurality of three-way vertex joints fitted concentrically around the lower-level elongated pipes, and a plurality of secondary support pipes fitted between and perpendicular to the lower-level elongated pipes at the secondary support pipe ends into the three-way vertex joint opening;
the upper surface support component comprising a plurality of securing pins, a plurality of upper-level elongated pipes comprising a shaft, ends, and one or more equally spaced ports along the surface of the pipe designed to receive a securing pin, a plurality of three-way vertex joints, a plurality of two-way vertex joints, and a plurality of secondary support pipes comprising a shaft and ends, wherein the upper-level elongated pipes are arranged perpendicular to the longitudinal axis with one or more three-way vertex joints fitted concentrically around the shafts of the upper-level elongated pipes, wherein the secondary support pipes can be fitted between and perpendicular to the upper-level elongated pipes at the ends via the three-way vertex joints fitted around the upper-level elongated pipes, and one or more two-way vertex joints connected to the upper-level elongated pipe ends wherein the ends of the secondary support pipes connect to the two-way vertex joints; and
wherein the upper surface support component is placed above the frame component and is attached to the frame component via one or more three-way vertex joints placed around the upper-level elongated pipes that connect to the proximal ends of the legs.

2. The support frame of claim 1, wherein the support frame further comprises leg end components consisting of the group selected from rubber stoppers or caster wheels.

3. The support frame of claim 1, wherein the upper surface support component is mounted to and above said frame component via a plurality of four-way vertex joints.

4. The support frame of claim 1, further comprising a power surge protector wherein the surge protector is fastened to one or more legs via a fastening means.

5. The support frame of claim 1, further comprising a hanging component and mesh fabric receiving component, the hanging component comprising attaching to the upper surface support component via a plurality of hook and loop fastener strips attached to the mesh fabric.

6. The support frame of claim 1, further comprising one or more plant trays rested along the upper surface support component.

7. The support frame of claim 1, wherein the ratio of the length dimension to the width dimension of the upper surface support component is substantially two to one.

9. A plant tray support frame, comprising:
a frame component, a plurality of plant trays, and an upper surface support component;
the frame component comprising a plurality of securing pins, a plurality of three-way vertex joints, a plurality of lower-level elongated pipes with one or more equally spaced ports along the surface of the pipe designed to receive a securing pin and ends, a plurality of secondary support pipes, and a plurality of legs comprising telescoping cylindrical pipes with proximal and distal ends placed perpendicular to the floor and a plurality of equally spaced ports along the surface of the legs designed to receive one or more securing pins, one or more leg end components placed at the distal end of the legs, wherein one or more three-way vertex joints are fitted concentrically around the legs to receive the ends of one or more lower-level elongated pipes or secondary pipes placed perpendicular to the longitudinal axis, a plurality of three-way vertex joints fitted concentrically around the lower-level elongated pipes, and a plurality of secondary support pipes fitted between and perpendicular to the lower-level elongated pipes at the secondary support pipe ends into the three-way vertex joint opening;
the upper surface support component comprising a plurality of securing pins, a plurality of upper-level elongated pipes comprising a shaft, ends, and one or more equally spaced ports along the surface of the pipe designed to receive a securing pin, a plurality of three-way vertex joints, a plurality of two-way vertex joints, and a plurality of secondary support pipes comprising a shaft and ends, wherein the upper-level elongated pipes are arranged perpendicular to the longitudinal axis with one or more three-way vertex joints fitted concentrically around the shafts of the upper-level elongated pipes, wherein the secondary support pipes can be fitted between and perpendicular to the upper-level elongated pipes at the ends via the three-way vertex joints fitted around the upper-level elongated pipes, and one or more two-way vertex joints connected to the upper-level elongated pipe ends wherein the ends of the secondary support pipes connect to the two-way vertex joints;
wherein the plant trays are arranged parallel to and above the secondary support pipes of the upper surface support component and supported by the upper-level elongated pipes; and
wherein the upper surface support component is placed above the frame component and is attached to the frame component via one or more three-way vertex joints connected to the proximal ends of the legs.

10. The plant tray support frame of claim 9, further comprising one or more four-way vertex joints fitted concentrically around the upper-level elongated pipes, a plurality of stand support pipes comprising telescoping cylindrical pipes with proximal and distal ends placed parallel to the longitudinal axis and a plurality of equally spaced ports along the cylindrical surface of the stand support pipes designed to receive one or more pins to secure the stand support pipes, and one or more three-way vertex joints, wherein the secondary support pipes four-way vertex joints and three-way vertex joints interconnect to create an additional level on the frame.

11. The plant tray support frame of claim 9, further comprising a power surge protector wherein the surge protector is fastened to one or more legs via a fastening means.

12. The plant tray support frame of claim 9, further comprising a mesh insert comprising a hanging component and mesh fabric receiving component, the hanging component comprising fabric to wrap around one or more upper-level support pipes via a plurality of hook and loop fastener strips attached to the fabric.

13. The plant tray support frame of claim 9, wherein the ratio of the length dimension to the width dimension of the upper surface support component is substantially two to one.

14. The plant tray support frame of claim 9, wherein the ground support means is selected from the group consisting of caster wheels and table ends.

15. The plant tray support frame of claim 9, wherein the lower level support component further comprises one or more pivoting vertex joints placed concentrically around each of the legs and an arm component connected to each pivoting vertex joint component.
